(19) United States
(12) Patent Application Publication
(10) Pub. No.: US 2016/0076572 A1
(43) Pub. Date: Mar. 17, 2016

(54) Self-Locking Pin

(71) Applicant: John Roy O'Dell, Beatty, NV (US)

(72) Inventor: John Roy O'Dell, Beatty, NV (US)

(21) Appl. No.: 14/851,320

(22) Filed: Sep. 11, 2015

Related U.S. Application Data
(60) Provisional application No. 62/049,290, filed on Sep. 11, 2014.

(51) Int. Cl. F16B 19/00

(52) U.S. Cl. CPC F16B 19/002; F16B 2019/006

(57) ABSTRACT

A self-locking pin is provided that includes a head and a longitudinally-extending shaft. The shaft has an open longitudinally-extending long, narrow open slot with a longitudinally-extending long, narrow detent spring disposed within the slot. The detent spring is anchored in the anchor end of the slot; the detent spring has a detent disposed at the latch end of the slot. Some embodiments of this self-locking pin may be used for replacement of the hammer and trigger pins of some types of firearms, such as the AK-47.

### CROSS-REFERENCE TO RELATED APPLICATIONS

This nonprovisional application claims the benefit of co-pending U.S. Provisional Patent Application No. 62/049,290, filed on Sep. 11, 20114, which is incorporated herein in its entirety.

### FIELD OF INVENTION

This invention relates generally to a self-locking pin, and more particularly, to a self-locking pin with a longitudinally-extending open slot accommodating a longitudinally-extending detent spring; the spring has a detent at one end and the opposing end is anchored in the slot.

### BACKGROUND OF THE INVENTION

Conventional self-locking pins are used when a pin must be securely locked within a pinhole or within multiple aligned pinholes, often in order to secure separate pieces into one assembly. Conventional self-locking pins may be of the plunger type and have a plunger hole at the pin end. The plunger includes a top detent that can be recessed within the plunger hole or that can protrude out of the plunger hole to engage the edge of the pinhole (or the edge of the innermost pinhole of multiple pinholes) into which the pin is inserted. A spring typically holds the plunger in its locked position, which is protruding upward through the plunger hole. The detent can be released by pressing the detent and plunger further inside the plunger hole against the spring pressure. U.S. Pat. No. 7,147,420 issued to Baus, et al. and assigned to Pivot Point, Inc. is an example of this type of pin.

Other conventional self-locking pins are of the push-button release type. The release button on the end moves a shaft aligned in the center of the pin and causes alignment of the shaft with the detent in such a way that the detent is permitted to withdraw into the pin. U.S. Pat. No. 4,297,063 issued to Hart and assigned to Hi Shear Corporation is an example of this type of self-locking pin.

However, these conventional self-locking pins are not suitable for all applications. For instance, in some applications a strong vibration may cause conventional pins to fail in their purpose of reliably maintaining a secure lock. In other situations the available diameter within the structure is limited, and conventional self-locking pins that meet the diameter limitations do not have adequate strength.

For example, there is a need for a self-locking pin that can be effectively used as a replacement for the hammer pin and trigger pin in some types of firearms, even though these firearms are subject to extreme vibration when in use.

As a further matter, conventional pins tend to have many small pieces that interact to provide the functionality of the pin. This increases the cost of manufacturing and increases the failure rate.

Accordingly, there is a need for a more robust self-locking pin that is stronger, is more vibration resistant and is lower in complexity than conventionally available self-locking pins.

### BRIEF SUMMARY OF THE INVENTION

The present invention is directed to a self-locking pin that includes a head and a shaft that extends longitudinally from the head. The shaft has a head end and an opposing insertion end with a long, narrow open slot extending longitudinally from at or near the head end toward the insertion end. The slot has an anchor end and an opposing latch end. Disposed within the slot is a longitudinally-extending long, narrow detent spring having an anchor leg end and an opposing detent end. The anchor leg of the detent spring is secured in the anchor end of the slot. The detent end of the detent spring has a detent disposed at the latch end of the slot.

The anchor leg of the detent spring is preferably pressed into a spring-anchoring hole at the anchor end of the slot. The cross-sectional shape of the detent spring is not important for the functioning of the inventive pin. For example, the detent spring may have a circular cross-section, rectangular cross-section, or a cross-section of another shape, though for simplicity of manufacture a circular cross-section is preferred.

In use, the detent is self-retracted as the self-locking pin is inserted into a pinhole (or pinholes), with the last pinhole through which the pin is inserted herein referred to as the “terminal pinhole.” When the self-locking pin is fully inserted, the detent spring returns to its relaxed position extending the detent outwardly and causing the detent to engage the terminal edge of the terminal pinhole, thereby locking the pin into position.

In the first embodiment the latch end of the slot is disposed at the head end of the shaft. In the second, third, fourth and fifth embodiments the latch end of the slot is disposed at the insertion end of the shaft. The third, fourth and fifth embodiments include a detent-locking mechanism that is a structure preventing the retraction of the detent, and thus preventing the slippage or extraction of the self-locking pin until detent-locking mechanism is manually removed or realigned.

An exemplary use of this self-locking pin is for the replacement of the hammer and trigger pins of some types of firearms, such as the AK-47. The inventive self-locking pin provides easier and more efficient assembly and disassembly of the firearm.

The inventive self-locking pin is strong in comparison to conventional pins, because only a small portion of the pin is removed to introduce the slot, thereby maintaining most of the original strength. The inventive self-locking pin is vibration resistant compared to conventional pins, because of the strength and sturdy anchor of the detent spring. The self-locking pin of the present invention also has fewer and larger parts than conventional self-locking pins.

These and other objects, features and advantages of the present invention will become more readily apparent from the attached drawings and from the detailed description of the preferred embodiments which follow.

### BRIEF DESCRIPTION OF THE SEVERAL VIEWS OF THE DRAWINGS

The preferred embodiments of the invention will hereinafter be described in conjunction with the appended drawings, provided to illustrate and not to limit the invention.

FIG. 1 is a side perspective view of a first embodiment of the self-locking pin of the present invention.

FIG. 2 is a top view of the head 60 and shaft 80 with slot 85 (without the detent spring 70 in the slot 85) of the first embodiment of the present invention.

FIG. 3 is a sectional view of the head 60 and shaft 80 with slot 85 taken along lines 3-3 of FIG. 2 of the first embodiment with the inclusion of the detent spring 70 of FIG. 8.

FIG. 4 is an expanded sectional view of the head 60 and shaft 80 with slot 85 taken along lines 4-4 of FIG. 2 with the inclusion of the detent spring 70 of FIG. 8.

FIG. 5 is a side view of the first embodiment of the present invention with exemplary dimension designations.

FIG. 6 is a side perspective view of a second embodiment of the self-locking pin of the present invention.

FIG. 7 is a top view of the head 60 and shaft 80 with slot 85 (without the detent spring 70 in the slot 85) of the second, third, fourth, and fifth embodiments of the present invention.

FIG. 8 is a perspective view of the detent spring 70 for insertion into the slot 85 of the shaft 80 of the first and second embodiment of the present invention.

FIG. 9 is a side view of the detent spring 70 for insertion into the slot 85 of the shaft 80 of the first and second embodiment of the present invention.

FIG. 10 is a sectional view of the head 60 and shaft 80 of the second embodiment taken along lines 10-10 of FIG. 7, with the shaft 80 having a slot 85 for receiving the detent spring 70.

FIG. 11 is a sectional view of the head 60 and shaft 80 of the second embodiment taken along lines 11-11 of FIG. 7 with the detent spring 70 inserted in the slot 85 of the shaft 80.

FIG. 12 is a sectional view of the head 60 and shaft 80 of the third embodiment taken along lines 12-12 of FIG. 7 with the detent spring 70 inserted in the slot 85 of the shaft 80 and showing a first aspect of a detent-locking mechanism (lock pin 90).

FIG. 13 is a sectional view of the head 60 and shaft 80 of the fourth embodiment taken along lines 13-13 of FIG. 7 with the detent spring 70 inserted in the slot 85 of the shaft 80 and additionally including a second aspect of a detent-locking mechanism (lock pin 90).

FIG. 14 is a side view of another aspect of the detent spring 70 that provides a non-assisted release.

FIG. 15 is a side view of a detent spring 70 of the fifth embodiment of the self-locking pin of the present invention illustrating, in combination with the integral detent lock of FIG. 16, a third aspect of the detent-locking mechanism.

FIG. 16 is a side view of an integral detent lock 65 of the fifth embodiment of the self-locking pin of the present invention.

FIG. 17 is a sectional view of the head 60 and shaft 80 of the fifth embodiment taken along lines 17-17 of FIG. 7, with the detent spring 70 inserted in the slot 85 of the shaft 80 and with the detent spring 70 in the locked position.

FIG. 18 is a sectional view of the head 60 and shaft 80 of the fifth embodiment taken along lines 18-18 of FIG. 7, with the detent spring 70 inserted in the slot 85 of the shaft 80 and with the detent spring 70 in the released position.

FIG. 19 is a view of a section of FIG. 18 with the portion indicated by the circle 19 in FIG. 18, which shows a retaining washer 94.

FIG. 20 is a head end view of an aspect that may be used with any of the embodiments of the present invention.

Like reference numerals refer to like parts throughout the several views of the drawings.

### DETAILED DESCRIPTION OF THE INVENTION

Shown throughout the figures, the present invention is directed toward a self-locking pin 50 that, compared to conventional self-locking pins, is stronger, more robust, more vibration resistant, and requires fewer parts to construct than conventional self-locking pins.

Because the cross-section of the self-locking pin 50 is reduced only by the relatively small area of the cross-section of the slot 85, the strength of the pin is maintained very near to its original specification. This produces a very strong, robust pin 50 relative to its diameter. The inventive self-locking pin 50 is resistant to vibration because the detent spring 70 is strong, sturdily anchored, and firmly maintains its locked position. Additionally, few parts are required to form the self-locking pin 50, and no small parts are needed. This increases the robustness while making it easier and more economical to manufacture the inventive self-locking pin.

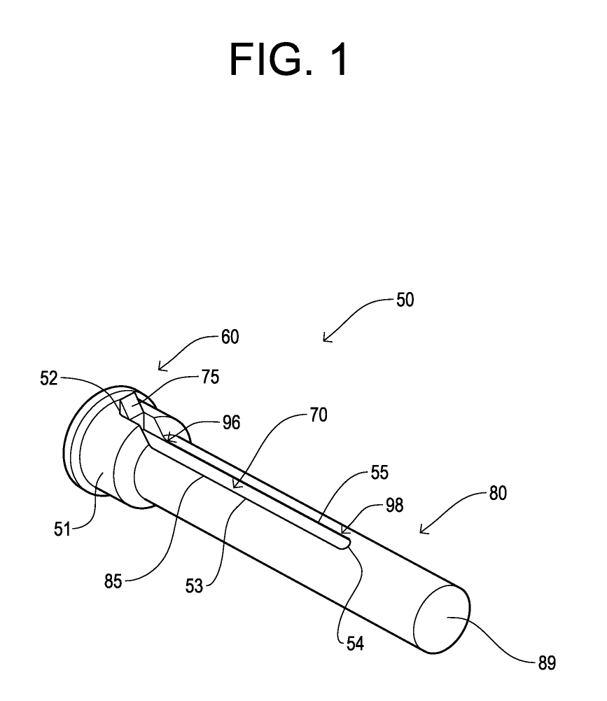

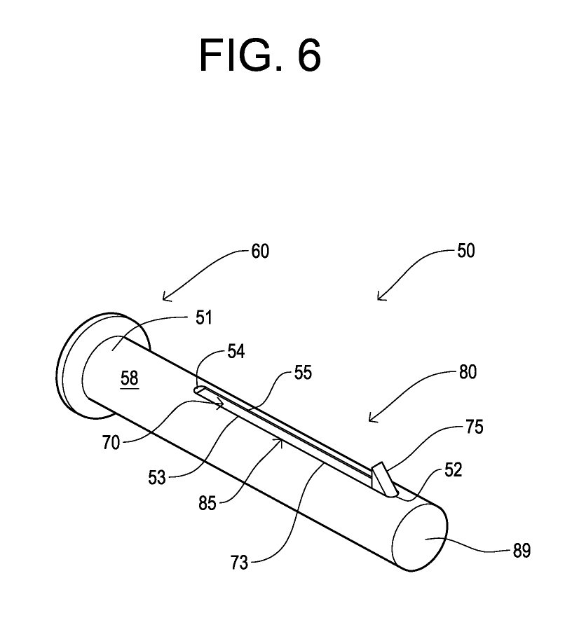

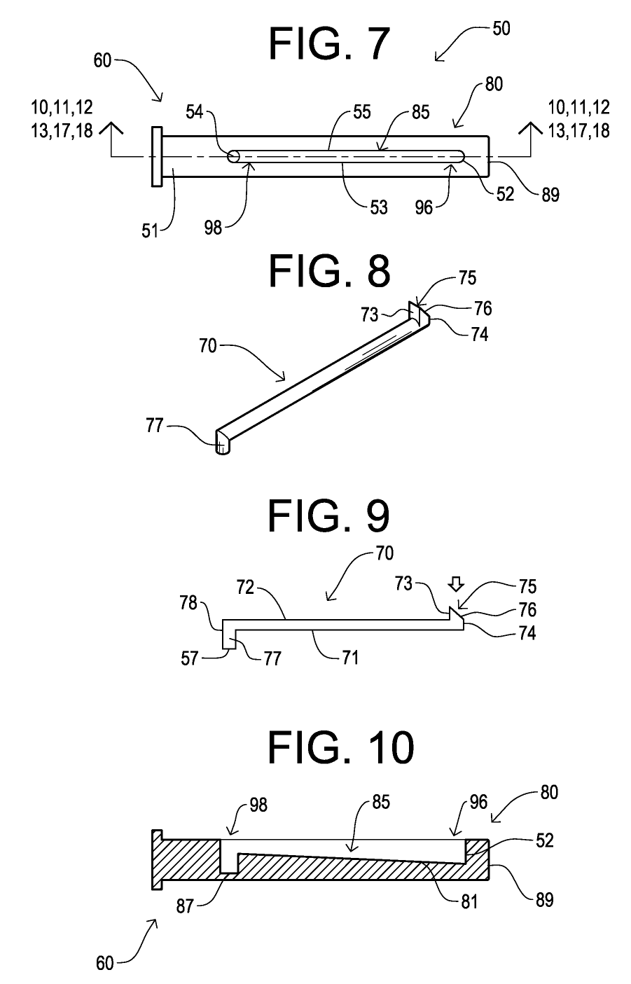

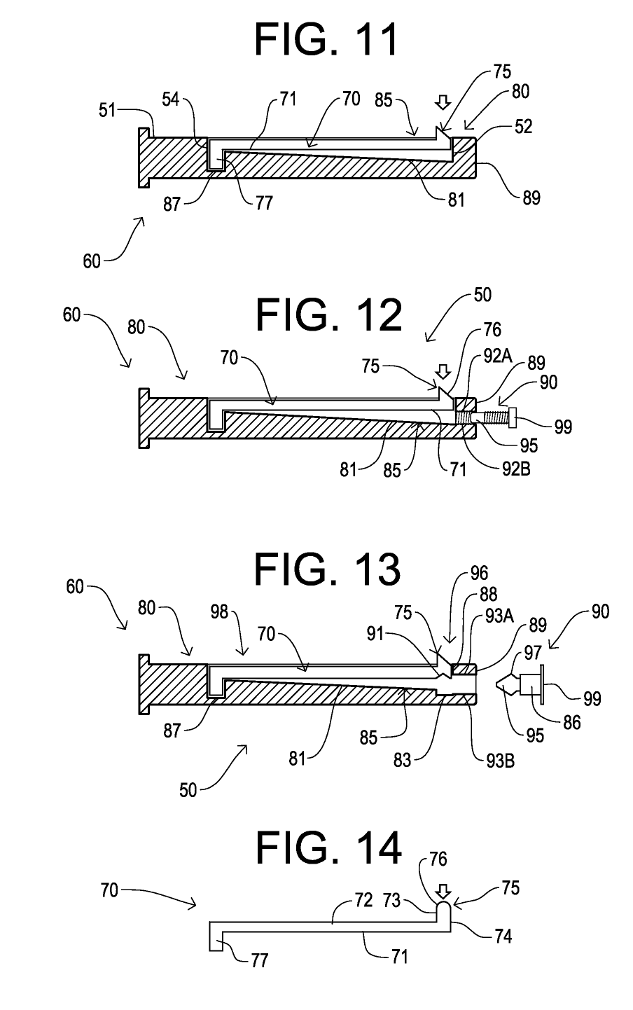

Five embodiments are presented. The first embodiment (FIGS. 1-5, 8-9, 19) has the detent 75 (or latch portion) near the head 60. The second (FIGS. 6-11, 19), third (FIGS. 7, 12, 19), fourth (FIG. 7, 13, 19), and fifth (FIGS. 15-19) embodiments have the detent 75 toward the distal end 89 of the shaft 80 of the self-locking pin 50. The third, fourth and fifth embodiments provide a detent-locking mechanism that physically prevents the retraction of the detent 75 and the slippage or extraction of self-locking pin 50, even during vibration. The third and fourth embodiments provide a first and second aspect of the detent-locking mechanism (lock pin 90). In the fifth embodiment the detent 75 is locked by means of a third aspect of the detent-locking mechanism (integral detent lock 65).

Referring now to FIG. 1, a self-locking pin, shown generally as reference number 50, is illustrated in accordance with the first embodiment of the present invention, which includes a proximal latching mechanism. As shown, the self-locking pin comprises a head 60 and a shaft 80 extending longitudinally from the head 60. The shaft 80 has an open longitudinally-extending long, narrow open slot 85 accommodating a longitudinally-extending long, narrow detent spring 70 (FIG. 4) disposed within the slot 85. The detent spring 70 is anchored in the anchor end 98 (FIG. 4) of the slot 85; the detent spring 70 has a detent 75 disposed at the latch end 96 (FIG. 4) of the slot 85. This first embodiment of the self-locking pin 50 is characterized by the proximal latching mechanism with the detent 75 of detent spring 70 and latch end 96 of slot 85 being disposed near or toward the head 60 of the self-locking pin 50. In its undistorted or relaxed position, the detent 75 extends above the circumference of the shaft 80 and engages a portion of a pinhole (through which the pin 50 has been inserted) to latch the self-locking pin 50 into the pinhole. The pin 50 may be inserted through one or, more often, multiple pinholes. This first embodiment of the self-locking pin is particularly suited for replacement of the hammer and trigger pins of some types of firearms, such as the AK-47. Replacement of the conventional hammer and trigger pins with the inventive self-locking pin allows the user to more quickly and easily assemble and disassemble the weapon.

The shaft 80 has a proximal head end 51 attached to the head 60 of the self-locking pin 50 and an opposing distal end, the insertion end 89, at the opposing end of the shaft 80. In use, the insertion end 89 is the distal portion of the shaft 80 that is first inserted into a single pinhole or into the initial pinhole of multiple pinholes. The distal end 89 of the shaft 80 may be blunt, as shown in FIGS. 1-5, or may be rounded, angled or otherwise shaped to meet the requirements of the particular application.

The shaft 80 is attached co-axially with the head 60. The shaft 80 of the first embodiment is a complex, multi-diameter shaft 80. The proximal wider shaft portion 51 attaches directly to the head 60 and has a diameter that is larger than the distal thinner shaft portion 89. The shaft 80 has an exterior surface 58 that is broken by the slot 85, which extends into both shaft portions, proximal wider shaft portion 51 and distal thinner shaft portion 89.

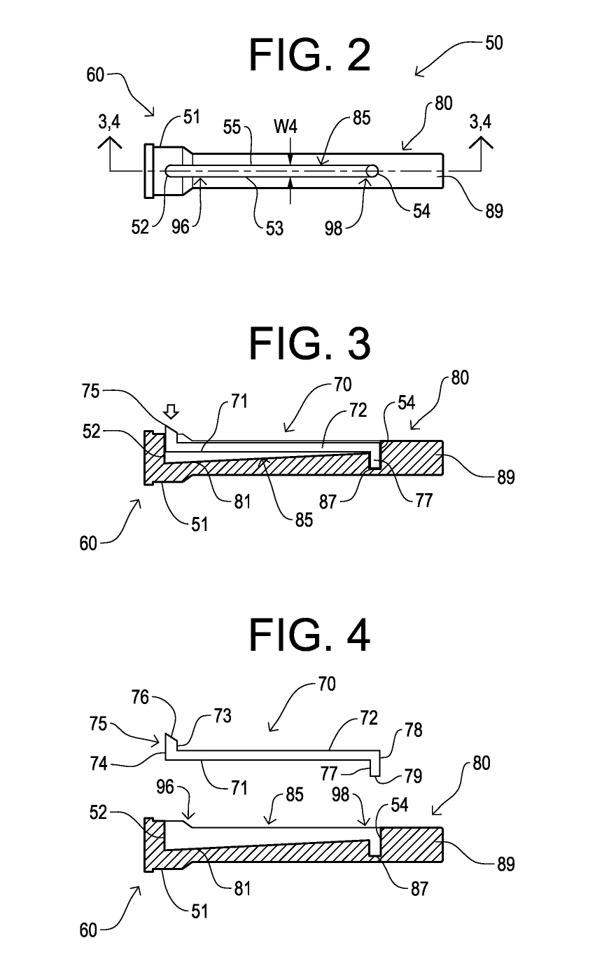

The shaft 80 is configured with an open long, narrow slot 85 that extends longitudinally and is configured to receive the detent spring 70. One end of the slot 85 is an anchor end 98 (FIGS. 2, 4) and the opposing end is a latch end 96. The detent spring 70 is anchored in the anchor end 98, and the detent 75 of the detent spring 70 is located within the latch end 96. In the first embodiment, the latch end 96 is disposed at or toward the head end 51 of the shaft 80, and the anchor end 98 is disposed at or toward the insertion end 89 of shaft 80.

The slot 85 is a long narrow open hole having sides defined by a longitudinally-extending first side wall 53, a laterally-extending anchor end wall 54, a longitudinally-extending second side wall 55 and a laterally-extending latch end wall 52. The slot 85 extends from a latch end 96 (where the detent 75 of detent spring 70 is disposed) toward an anchor end 98 (where the detent spring 70 is fixedly attached and anchored at anchor well 87, FIGS. 3-4). The slot 85 bottom surface is defined by a slot floor 81 (FIG. 4) which extends longitudinally from the latch end 96 of the slot 85 to end at anchor well 87 at the anchor end 98 of the slot 85. The anchor well 87 is a depression disposed at the anchor end 98 of slot 85. The anchor well 87 is configured to receive the spring anchor leg 77. The outer wall 78 of leg 77 fits against the laterally-extending anchor end wall 54 (FIG. 4). The bottom surface 57 (FIG. 9) of the spring anchor leg 77 fits against the top surface of the anchor well 87. The shape of the receiving anchor well 87 conforms to the shape of the spring anchor leg 77; therefore, if the spring anchor leg 77 is circular in cross-section as in FIG. 8, the anchor well 87 has a circular cross-section or if the spring anchor leg 77 is square in cross-section, the anchor well 87 has a square cross-section. The anchor leg 77 is preferably pressed into the anchor well 87. In use, the encircling walls of the pinhole(s) also help to retain the detent spring 70 in the proper place within the slot 85.

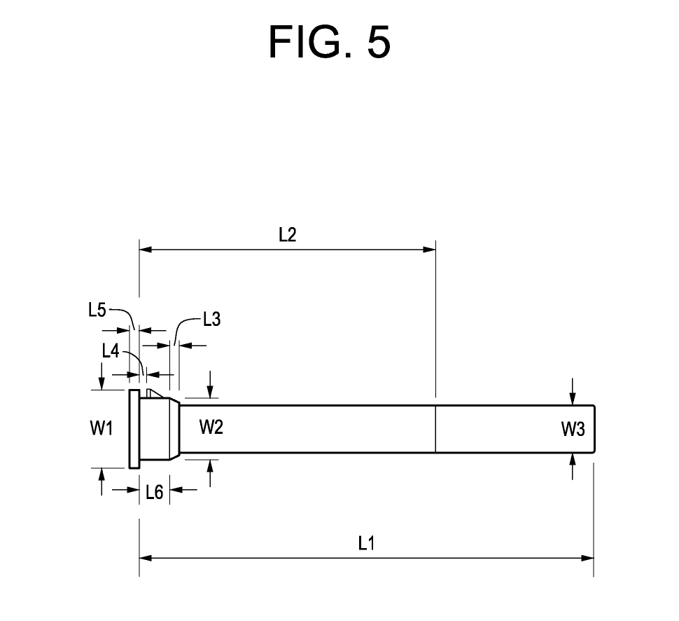

The slot 85 extends longitudinally a slot outer longitudinal length L2 (FIG. 5) that is at least three times the width of the slot outer lateral width W4 (FIG. 2).

Best seen in the cut view of FIG. 3, a longitudinally-extending long, narrow detent spring 70 is disposed within the slot 85. Detent spring 70 comprises an anchor leg 77 on one end of an elongated central detent spring rod 72 and a detent 75 on the opposing end of the spring rod 72. The elongated central detent spring rod 72 extends longitudinally within slot 85. The anchor end of the detent spring 70 has an inwardly (toward the interior of shaft 80) projecting anchor leg 77, and the latch end of the detent spring 70 has an outwardly (from the interior of shaft 80) projecting detent 75. The center axis of the anchor leg 77 on the anchor end of the detent spring 70 forms an approximately ninety-degree angle in a first direction (which will be the inward direction when the detent spring 70 is placed within the slot 85) with a center axis of the longitudinally extending detent spring rod 72. The center axis of the detent 75 on the opposing latch end of the detent spring 70 forms an approximately ninety-degree angle in a second direction (which will be the outward direction when the detent spring 70 is placed within the slot 85) with the center axis of the longitudinally extending detent spring rod 72.

The detent 75 has an inward (toward the center of detent 75) edge 73, an outer edge 74 and an upper edge 76 (FIGS. 4, 9). The inward edge 73 of the detent 75 extends upwardly a greater distance from the axial center of spring rod 72 than the outer edge 74 extends upwardly from the axial center of spring rod 72. For instance, the angle upper edge 76 forms with outer edge 74 may be approximately forty-five degrees, as seen in FIGS. 3-5, 8-9. Alternatively, a self-releasing detent 75 as seen in FIG. 14 may have a rounded upper edge 76.

The detent spring 70 may have a cross-section that is circular, rectangular, square or of another shape. Or the detent spring 70 may have a first cross-section that is of a first shape (for example the cross-section of anchor leg 77 may be square) while having a second cross-section that is of a second shape (for example, the cross-section of detent 75 may be circular as in FIG. 8). The detent spring 70 is preferably circular in cross-section.

The head 60 is an end or plate terminating the shaft 80. Head 60 is shown as circular but may be formed in other shapes, such as hexagonal or rectangular. The head 60 is preferably configured with a rotation slot 61 (FIG. 20) that allows a user to manually turn the self-locking pin 50, which also turns the detent 75 to a desired direction to facilitate removal of self-locking pin 50.

In use, the self-locking pin 50 is inserted into a receiving pinhole (or through multiple pinholes) with the angle of the upper edge 76 engaging with the initial edge of the pinhole(s) forcing the detent spring 70 inward to the slot floor 81, and thereby retracting the detent 75 and allowing the pin 50 to be easily inserted. After the detent 75 has passed through the receiving pinhole(s), the detent spring 70 is allowed to return to its relaxed or undistorted position with the detent 75 projecting outwardly above the plane of the shaft 80 surface. In that position, the detent 75 inward edge 73 engages with the terminal edge of the terminal pinhole (through which the detent 75 has just passed) preventing the retraction of the self-locking pin 50.

The second embodiment of the self-locking pin 50 is illustrated in FIGS. 6-11 and 19. The second embodiment shares most structural and functional aspects with the first embodiment. However, in contrast to the first embodiment which is characterized by a proximal latching mechanism with the detent 75 disposed at the proximal end of shaft 80, the second embodiment provides a distal latching mechanism in which the detent 75 is disposed at the distal end of the shaft 80. To deliver the change in orientation of the detent 75 of the second embodiment (and in contrast to the first embodiment) the anchor end 98 (FIG. 10) of the slot 85 is disposed at the proximal end of the shaft 80 and the latch end 96 (FIG. 10) of the slot 85 is disposed at the distal end of the shaft 80.

The third embodiment of the self-locking pin 50 is illustrated in FIGS. 8, 9, 12 and 19. The third embodiment shares most structural and functional aspects with the second embodiment. However the third embodiment additionally provides a first aspect of a detent-locking mechanism (lock pin 90) that serves to secure or lock the spring detent 75 in the outwardly projecting position above the plane of the shaft 80 surface, thus preventing the detent 75 from being accidentally retracted. In the third embodiment, the lock pin 90 may be configured similarly to a screw with a round or square head end 99 and an opposing cylindrical threaded insertion/contact end 95. To accommodate the lock pin 90, the distal end 89 of the shaft 80 is configured with a cylindrical threaded lock hole defined by threaded lock hole edges 92 (shown as 92A to designate the top portion in the cut view of FIGS. 12 and 92B to designate the bottom portion in the cut of FIG. 12) with threads that correspond to the threads of the threaded insertion/contact end 95. In the cross sectional view of FIG. 12 the upper portion of the cylindrical threaded lock hole 92 is labeled 92A and the lower portion of the cylindrical threaded lock hole 92 is labeled 92B.

In use, the self-locking pin 50 of the third embodiment is inserted into the receiving pinhole(s) while the detent 75 is self-retracted. After the detent 75 has passed through the terminal pinhole, the detent spring 70 returns to its relaxed or undistorted position with the detent 75 projecting outwardly above the plane of the shaft 80 surface. Though the detent 75 inward edge 73 is disposed against the outward edge of the terminal pinhole thereby preventing the retraction of the self-locking pin 50, an amount of jarring or vibration could cause the detent spring 70 to be jostled or worked inwardly toward the bottom of the slot floor 81, thus retracting the detent 75 and letting the self-locking pin 50 draw back outward from the receiving hole. To prevent this inadvertent retraction, the insertion/contact end 95 of lock pin 90 is inserted into the corresponding cylindrical threaded lock hole 92 with the threads of the insertion/contact end 95 engaged with the threads of the lock hole 92. The self-locking pin 50 is thereby held securely, even during vibration episodes, until the release of the lock pin 90 by unscrewing the screw-like lock pin 90 of the third embodiment.

The fourth embodiment of the self-locking pin 50 is illustrated in FIGS. 13 and 19. The fourth embodiment is structurally and functionally very similar to the third embodiment but provides a second aspect of the detent-locking mechanism (lock pin 90) and a lock pin receiving hole defined by lock pin receiving hole edges 93 (shown as 93A and 93B) in the distal end 89 of the shaft 80. However, the fourth embodiment presents a different type of lock pin 90. Whereas the lock pin 90 of the third embodiment was threaded, the lock pin 90 of the fourth embodiment has an angular insertion/contact end 95. Also in contrast to the third embodiment, to accommodate the angular lock pin 90 a notch (defined by spring notch edges 91) is cut into the bottom of the detent spring 70. The angular insertion/contact end 95 has an outwardly projecting frustum-to-cone shape projection 97 that engages with the angular lock hole formed by angular lock pin receiving edges 93, as seen in FIG. 13.

Attached to head 99 is a projecting cylinder 86 with an insertion-end frustum-to-cone shape projection 97 forming the insertion/contact end 95. The frustum (a truncated cone shape lying between the plane of the attachment to the projecting cylinder, the small base, and the plane of the attachment to the wider base of the distal cone, the wide base) is attached to the projecting cylinder 86 with the wider base projecting away from the head 99. The frustum narrow base is attached to the projecting cylinder 86. The frustum wide base is attached to the base of the distal cone. The distal cone has a vertex that forms the outermost point or insertion tip of the insertion/contact end 95 of lock pin 90.

The bottom of the detent spring 70 is cut with spring notch edges 91 corresponding to the size and shape of the frustum-to-cone shape projection 97. In cross-section, as seen in FIG. 13, the upper portion of the frustum-to-cone shape projection 97 appears mountain-shaped and the spring notch edges 91 form a corresponding mountain shape to receive the frustum-to-cone shape projection 97 when the pin lock 90 of the fourth embodiment is inserted.

As in the third embodiment, the insertion of the lock pin 90 secures or locks the spring detent 75 in the outwardly projecting position above the plane of the shaft 80 surface, thus preventing the detent 75 from being accidentally retracted.

In the second embodiment, the distal end of the self-locking pin 50 was solid from the latch end wall 52 to the outward most wall of distal end 89. In the third, fourth, and fifth embodiments, the distal end 89 of shaft 80 has a cylindrical opening defined by lock pin receiving hole edges 92 or 93, and the latch end wall is a partial wall 88 (FIG. 13). In the fourth embodiment the slot floor area 83 at the proximal end of the lock pin receiving hole edges 93 is preferably flat or generally flat, as seen in FIG. 13.

In use, the self-locking pin 50 of the fourth embodiment is inserted into the receiving pinhole(s) while the detent 75 is self-retracted. After the detent 75 has passed through the receiving pinhole(s), the detent spring 70 returns to its relaxed or undistorted position with the detent 75 projecting outwardly above the plane of the shaft 80 surface. To prevent accidental retraction, the insertion/contact end 95 of lock pin 90 is inserted into the lock pin receiving hole defined by lock pin receiving hole edges 93 with the frustum-to-cone shape projection 97 of the insertion/contact end 95 engaged with the notch defined by spring notch edges 91 disposed on the bottom of the detent spring 70.

FIG. 14 illustrates a detent spring 70 with a rounded detent 75. The rounded detent 75 is an outward extension from detent spring rod 72 that may have a cross-section that is half round, triangular, a rounded triangle or the like. The rounded detent 75 can be incorporated into any of the embodiments of the invention, but has been found to be most useful in the embodiments with a detent-locking mechanism. Whereas the angular detent 75 must be pushed inward to release the inward edge 73 from the outward edge of the receiving hole until angular detent 75 is below the edge of the receiving hole, the rounded detent 75 is self-retracting. If a user wishes to secure the rounded detent 75 outwardly extended, then a detent-locking mechanism, as discussed below, must be used.

The fifth embodiment of the self-locking pin 50 is illustrated in FIGS. 15-19. The fifth embodiment is structurally and functionally similar to the fourth embodiment but provides a third aspect of the detent-locking mechanism (integral detent lock 65). Both the fourth and fifth embodiments include a lock pin receiving hole defined by lock pin receiving hole edges 93 in the distal end 89 of the shaft 80. Both also include a device to lock the detent spring 70 in its outwardly extended position. However, the locking device of the fourth embodiment, lock pin 90, is a separate removable element, in contrast to the locking device of the fifth embodiment, an integral detent lock 65, which is securely fixed within the shaft 80 of the self-locking pin 50.

The fifth embodiment also provides a rounded detent 75 (FIGS. 17-18) that facilitates easy removal of the self-locking pin 50 from the receiving hole. Though the pin 50 is easy to remove when desired, the detent 75 can be secured in the outwardly projecting locked position via the integral detent lock 65.

The detent spring 70 of the fifth embodiment is similar to the detent spring 70 of FIG. 14 but additionally includes a downwardly projecting protuberance 79 which is disposed generally opposite the outwardly projecting detent 76 at the distal end of central detent spring rod 72.

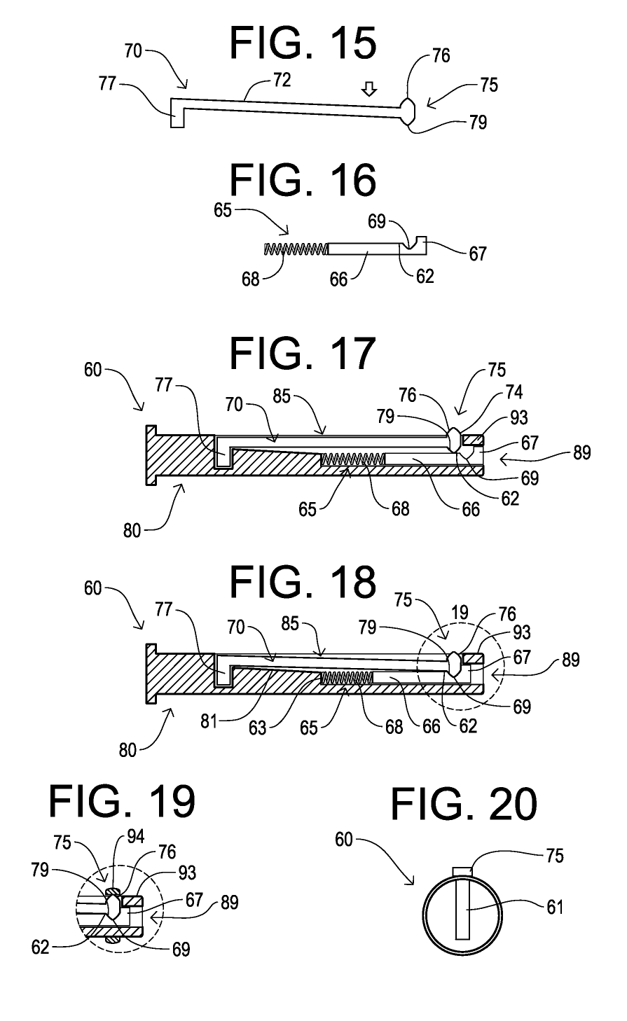

The integral detent lock 65 of the fifth embodiment, as seen in FIG. 16, extends longitudinally from a coil spring 68 on the left to an integral detent lock shaft 66 that ends at the integral detent lock distal end 67 on the right. The coil spring 68 is fixedly attached to a wall of an indentation 63 (FIG. 18) in the slot floor 81. The upper portion of the integral detent lock shaft 66 is configured with a protuberance receiver that is sized and shaped to accommodate the downwardly projecting protuberance 79. The protuberance receiver is defined by protuberance receiver edges 69. The protuberance receiver 69 is illustrated in FIG. 16 as a rounded hollow corresponding to the shape of the bottom of protuberance 79 of the detent spring 70.

To use the self-locking pin 50 of the fifth embodiment, the user pushes inwardly on the integral detent lock distal end 67 thereby slightly compressing the coil spring 68 and allowing the protuberance receiver 69 to be positioned under the protuberance 79 of detent spring 70. Then the distal end 89 of the self-locking pin 50 is inserted into the receiving hole or holes while the detent 75 is self-retracted with the protuberance 79 seated in the protuberance receiver 69. When the detent spring 70 reaches the opposite end of the hole (or the opposite end of the last of multiple holes), the detent 75 returns to its relaxed position with the detent 75 projecting outwardly above the plane of the shaft 80 surface. The compression on the integral detent lock 65 is also released and the integral detent lock 65 moves outward with the lip 62 at the edge of the protuberance receiver edges 69 moving under the protuberance 79 and securing the detent 75 in the outwardly projecting position.

Optionally, a small tool can be provided to facilitate insertion of the self-locking pin 50 of the fifth embodiment. After the user has pushed the integral detent lock distal end 67 inwardly to compress the coil spring 68 and move the protuberance receiver (defined by edges 69) into a position accommodating the protuberance 79 of detent spring 70, the small tool can hold the detent 75 in this retracted position while inserting the distal end 89 of the self-locking pin 50 into the receiving hole. The tool can be released as the detent 75 enters the receiving hole.

As a second option, a retaining washer 94 (FIG. 19) may be utilized to assist in the insertion of the self-locking pin 50 of the fifth embodiment. After the user has pushed the integral detent lock distal end 67 inwardly to compress the coil spring 68 and move the protuberance receiver (defined by edges 69) into a position accommodating the protuberance 79 of detent spring 70, the retaining washer can be slid onto detent 75 to hold it in the retracted position while inserting the distal end 89 of the self-locking pin 50 into the receiving hole. When the retaining washer 94 is pushed against the edge of the pinhole (or the edge of the outermost pinhole of multiple pinholes), it tends to slip off the detent 75 and onto shaft 80 and then may be pushed along the shaft 80 toward head 60.

To release the self-locking pin 50 of the fifth embodiment, the user pushes inwardly on the integral detent lock distal end 67 and compresses the coil spring 68. The lip 62, which is the top surface of the integral detent lock shaft 66 at the edge of the protuberance receiver edges 69, is moved inwardly and protuberance receiver (defined by edges 69) is then positioned under the protuberance 79. The protuberance 79 moves into protuberance receiver defined by edges 69, which allows the detent 75 to retract inwardly. The detent 75 is sufficiently retracted so that it does not catch on the edges of the receiving hole(s) as the self-locking pin 50 is manually extracted.

FIG. 20 illustrates an aspect of head 60 that is usable with all embodiments of the invention. In some applications of the self-locking pin 50 it may be desirable to provide a user with the ability to align the pin 50 in a particular orientation so as to allow the detent 75 to be in a particular orientation, such as for convenient access. For example, if the self-locking pin 50 is used to replace a trigger pin in a gun, turning the detent 75 to an upward orientation may help the user access the detent 75 within the tight space of the interior of the gun. To facilitate this, a slot 61 can be provided within the head 60 of the pin 50. The slot 61 may extend the full diameter of the head or may extend only partially (such as 50-90%) across the diameter, as shown in FIG. 20. If a partial slot 61 is provided, the top of slot 61 may be aligned with the detent 75, so it is easy for the user to determine the orientation of a detent 75 that he or she cannot see. The slot 61 may be used by inserting a flat-blade screwdriver into the slot 61 and manually rotating the entire pin 50 to the desired orientation.

The detent spring 70 is preferably formed of spring steel or an equivalent material. Generally a stainless spring steel material is preferred. The detent 75 and detent spring 70 may be milled or formed by other conventional methods. The remaining portions of the self-locking pin 50 are preferably made of metal, but in some applications some portions may be formed of a plastic or plastic may be used to provide a coating to particular components. For instance, in the second aspect of the detent-locking mechanism, the lock pin 90 may be formed wholly or partially of plastic; in the third aspect of the detent-locking mechanism, the integral detent lock 65 or the integral detent lock shaft 66 can be made wholly or partially of plastic; the head 60 or parts of the shaft 80 may be coated with plastic; or the like.

The sizes of all elements (including the head 60, shaft 80, slot 85, detent spring 70, detent 75, integral detent lock 65, 90) of the self-locking pin 50 may be varied to meet the needs of the particular application of use. The shaft 80 may have a single diameter W3 (FIG. 5), such as the shaft 80 shown in FIG. 6, or may have multiple diameters W2, W3 (such as the shaft shown in FIG. 1, with a smaller distal diameter of insertion end 89 and a wider proximal diameter of the head end 51). Because the self-locking pin can be utilized in many applications, the shaft diameter W3 (or diameters W2, W3) and the length L1 (FIG. 5) may vary to meet the requirements of the particular application. Though the self-locking pin 50 of the various embodiments may be formed with very large or very small dimensions to accommodate various structural specifications, an exemplary diameter W3 of the shaft 85 is from 0.1 to 1.0 inches, an exemplary length L1 of shaft 85 is from 0.5 to 5 inches, an exemplary length L1+L5 of the entire pin 50 is from 1 to 5.5 inches, and an exemplary width W4 (FIG. 2) of slot 85 is from 0.01 to 0.2 inches. In a particular application, such as for replacing the trigger pin or hammer pin of a weapon, the diameter W3 of the shaft 85 may be 0.195, the length L1+L5 of the entire pin 50 is 1.41, the length L2 of the slot 85 is 1.35 inches, and the width W4 (FIG. 2) of slot 85 is 0.066 in.

In summary, the design of the inventive self-locking pin 50 produces a very strong, robust pin relative to its diameter because only a relatively small area of shaft 80 needs to be removed to create the slot 85. Consequently, the pin 50 retains most of its original strength. Therefore, in situations in which the available diameter within the pinhole structure is limited, the self-locking pin 50 is usable when conventional self-locking pins that meet the diameter limitations do not have adequate strength.

The self-locking pin 50 maintains a secure lock. It is resistant to vibration because the detent spring 70 is not a separate piece but is firmly anchored within the slot 85. Additional vibration resistance is delivered by preventing the retraction of the detent spring 70 through the lock pin 90 of the third and fourth embodiments and the integral detent lock 65 of the fifth embodiment. The vibration resistance is particularly of value when the pin 50 is used in a weapon because of the inherent vibration produced during the normal operation of the weapon. The design of the inventive pin 50 also utilizes no small parts, which decreases manufacturing costs and increases the sturdiness of the pin 50.

The invention illustratively disclosed herein may be suitably practiced in the absence of any element which is not specifically disclosed herein.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

I claim:

1. A pin, comprising:
a head;
a shaft extending longitudinally from said head; said shaft having an exterior surface, a shaft head end, a shaft insertion end, at least one shaft lateral diameter measurement and at least one shaft longitudinal length measurement; said shaft configured with an open slot extending longitudinally from toward said head end to toward said insertion end; said slot defined by a longitudinally-extending first side wall, a laterally-extending latch end wall, a longitudinally-extending second side wall, a laterally-extending anchor end wall, a slot floor, and an anchor well disposed at said anchor end wall; wherein said slot floor and said anchor well together form the bottom of said slot; wherein said slot extends longitudinally a slot outer longitudinal length that is at least three times a slot outer lateral width; and
a longitudinal detent spring anchored in said anchor well, wherein said detent spring comprises a detent and an anchoring mechanism; whereby said detent spring in its normal undistorted position is configured to latch said pin in a receiver.
